(19) United States
(12) Patent Application Publication
(10) Pub. No.: US 2014/0076231 A1
(43) Pub. Date: Mar. 20, 2014

(54) PRINTING STENCILS FOR APPLYING A PRINTING PATTERN TO A SUBSTRATE AND METHOD FOR PRODUCING A PRINTING STENCIL

(71) Applicants: Joachim Hrabi, Lenningen-Gutenberg (DE); Christian Koenen, Ottobrunn-Riemerling (DE); Ralf Weber, Riemerling (DE); Markus Engel, Taufkirchen (DE)

(72) Inventors: Joachim Hrabi, Lenningen-Gutenberg (DE); Christian Koenen, Ottobrunn-Riemerling (DE); Ralf Weber, Riemerling (DE); Markus Engel, Taufkirchen (DE)

(73) Assignees: KOENEN GMBH, Ottobrunn (DE); CHRISTIAN KOENEN GMBH, Ottobrunn (DE)

(21) Appl. No.: 13/980,962

(22) PCT Filed: Jan. 27, 2012
(86) PCT No.: PCT/EP12/00363

§ 371 Date: Nov. 27, 2013

(30) Foreign Application Priority Data
Jan. 27, 2011 (DE) 10 2011 003 287.8

(51) Int. Cl. B05C 21/00; B23K 26/38

(52) U.S. Cl. CPC B05C 21/005; B23K 26/38
USPC 118/504; 264/400; 219/121.72; 430/325

(57) ABSTRACT

The present invention relates to a printing stencil, for example, for applying a contacting (contact finger, busbar(s)) to a substrate of a solar cell and to a method for producing such a printing stencil. The printing stencil can include a carrier layer and a structure layer located below the carrier layer, the structure layer having at least one printed image opening which corresponds to at least a portion of the printed image of the contacting (contact finger, busbar(s)), the carrier layer having one or more carrier layer openings and the one or more carrier layer openings overlapping when the printing stencil is viewed from above, with respect to the printed image opening in such a manner that the printing stencil has an opening which is formed from the at least one printed image opening and the one or more carrier layer openings, and is suitable for applying contacting material to the substrate through the opening.

The present invention relates to a printing stencil for applying a printing pattern, in particular a contacting, to a substrate, in particular to a substrate of a solar cell, comprising a carrier layer and a structure layer which is located below the carrier layer, the structure layer having at least one printed image opening which corresponds to at least a portion of the printed image of the printing pattern, and the carrier layer having one or more carrier layer openings.

The present invention further relates to a method for producing a printing stencil for applying a printing pattern, in particular a contacting, to a substrate, in particular to a substrate of a solar cell, comprising a carrier layer and a structure layer which is located below the carrier layer, the structure layer having at least one printed image opening which corresponds to at least a portion of the printed image of the printing pattern, and the carrier layer having one or more carrier layer openings, comprising the steps of providing the carrier layer, providing a structure layer which is located below the carrier layer, forming at least one printed image opening, which corresponds to at least a portion of the printed image of the printing pattern, in the structure layer and forming one or more carrier layer openings in the carrier layer.

### BACKGROUND OF THE INVENTION

From the prior art, it is conventionally known in solar cell printing technology to apply a contacting to a substrate of a solar cell by means of a printing screen. In particular, it is conventionally known to print a metal coating, contacting or conductor tracks of a contacting of a solar cell substantially using printing screens, by a printing paste, which mostly comprises silver, being applied by means of a doctor blade through printed image openings of a printing screen to a substrate of the solar cell, the printed image openings of the printing screen substantially corresponding to the printed image of the contacting of the solar cell to be printed.

Such printing screens have a wire screen fabric which is clamped in a frame and embedded in a photographic emulsion layer (see, for example, DE 10 2007 052 679 A1). The photographic emulsion layer has the printed image openings which correspond to the printed image of the contacting to be printed, the screen fabric also filling the printed image openings. During the production of such printing screens, the wire screen fabric is generally clamped to a frame and then coated with a photosensitive material. The printed image is subsequently structured.

However, when such printing screens are used for the application of the contacting of the solar cell to the solar cell substrate, there result disadvantages, in particular with regard to the printing of the so-called contact finger of a front contacting of the solar cell. The contact fingers are intended to be printed on the substrate such that they have the smallest possible width in order to reduce shading of the solar cell substrate by the front-side contacting and consequently to increase the energy efficiency of the solar cell. At the same time, with regard to the energy efficiency of the solar cell, the contact finger must allow a flow of current with the least possible electrical resistance, that is to say, the contact fingers must be constructed with the largest possible aspect ratio since the electrical resistance of the contact fingers is dependent on the cross-section of the contact fingers. The aspect ratio of the contact fingers is in particular intended to be constructed to be as uniform as possible over the entire length of the contact fingers.

When printing screens are used for applying the contacting of the solar cell to the solar cell substrate, there are in particular the disadvantages described below. The screen fabric and in particular intersection points of the screen fabric in the region of the printed image openings of the photographic emulsion layer impair the uniformity of the paste application to the substrate of the solar cell during printing. This results in unfavourable contractions in the conductor cross-section of the contact fingers and a disadvantageous waved edge of the printed image. Furthermore, the maximum achievable paste thickness, and thereby the maximum achievable height of the printed contact fingers, to which the aspect ratio is directly proportional, is significantly limited by the screen fabric structure in the region of the printed image openings.

An expansion of the fabric is further produced during printing by the pressure of the doctor blade owing to the resilient properties of the screen fabric, whereby a distortion of the printed image can occur. When the substrate is printed several times with different printing screens, a printing operation is normally carried out in several steps with different screens in order to print portions of the contacting in steps each time. In transition regions of the overall printed image, in which printed images of different printing screens are adjacent to each other, using conventional printing screens, owing to the above-described distortion of the individual partial printed images, there may be occurrences of unevenness in the overall printed image.

Furthermore, when printing screens are used, owing to the desired large open face of the printing pattern of the screens, a very fine fabric is required in order to stabilise the printing screen but is very susceptible to damage and consequently permits only short service-lives.

### SUMMARY OF THE INVENTION

With regard to the above-described disadvantages of the use of conventionally known printing screens for the printing of solar cell substrates for applying a contacting to a substrate, in particular to a substrate of a solar cell, an object of the present invention is to provide an improved solution for applying a contacting to a substrate, in particular to a substrate of a solar cell, in which the above-described disadvantages which occur during the use of conventionally known printing screens can be avoided.

Another object of the present invention is to provide an improved solution for the application of a contacting to a substrate, in particular to a substrate of a solar cell, in which the contacting and in particular the contact fingers can be applied with a uniform printed image. In particular, an object of the present invention is to provide an improved solution for the application of a contacting to a substrate, in particular to a solar cell in which the contact fingers can be applied with the highest possible aspect ratio which is uniform over the entire length of the contact fingers.

Furthermore, an object of the present invention is to provide an improved solution for the application of a contacting to a substrate, in particular to a substrate of a solar cell, with which occurrences of unevenness in the overall printed image when different printing means are used with different printed images can be prevented and, furthermore, longer service-lives can also be achieved.

In order to achieve the above-described objects of the present invention, a printing stencil for applying a printing pattern to a substrate according to claim 1 and a method for producing a printing stencil according to claim 12 are proposed. The dependent claims relate to preferred embodiments of the present invention.

A printing stencil for applying a printing pattern, in particular a contacting, to a substrate, in particular a substrate of a solar cell, according to the present invention comprises a carrier layer and a structure layer which is located below the carrier layer or which is arranged under the carrier layer. In this instance, there is preferably provision for the carrier layer to be provided on the doctor-blade side and the structure layer on the substrate side.

According to the invention, the structure layer has at least one printed image opening which corresponds to at least a portion of the printed image of the printing pattern, the carrier layer has one or more carrier layer openings and the one or more carrier layer openings overlap, when the printing stencil is viewed from above, with respect to the printed image opening in such a manner that the printing stencil has an opening which is formed from the at least one printed image opening and the one or more carrier layer openings and is suitable for applying a print medium, such as contacting material, through the opening to the substrate.

Owing to the use of such a printing stencil according to the invention for applying a printing pattern, in particular a contacting, to a substrate, in particular to a substrate of a solar cell, instead of a conventional screen printing stencil, the carrier layer which is preferably of a stable carrier material, such as metal or plastics material, affords a large number of advantages.

In particular, according to the invention, it is advantageously possible to open the printed image opening of the printing stencil in a selective manner for the printed image of the printing pattern, in particular the contacting and optionally in particular the contact fingers of a contacting, it thereby being possible to avoid the disadvantage of the printing screens relating to the covering of the printed image opening by meshes and in particular mesh knots of the screen fabric. Consequently, in particular contact fingers can advantageously be printed with a high aspect ratio which is at the same time uniform over the entire length of the contact fingers. In particular, it is consequently possible to increase the paste application, to ensure a contact finger cross-section which is uniform over the entire length and to achieve straight printing edges. Consequently, for example, the conductivity of a contacting and in particular of the contact fingers can be improved, even with the smallest of finger widths.

Furthermore, the carrier layer, which preferably forms over its complete surface-area a base member of the printing stencil, produces an advantageously higher level of mechanical strength. Consequently, the expansion of the printed member when the printing is applied by the doctor blade can be reduced, whereby a more uniform, more positionally precise and in particular undistorted overall printed image is made possible, even when the printed pattern or the contacting is printed in several steps (so-called stacking) with printing stencils having a plurality of different printed images. Finally, a longer service-life than when conventionally known printing screens are used is made possible.

In comparison with the use of standard stencils without any structure layer (for example, sheet metal stencils), an improved sealing effect is advantageously achieved on the substrate side.

Preferably, the one or more carrier layer openings have opening walls which are peripherally exposed. This has the advantage that the printing stencil can be produced in a particularly simple manner since no portions of the structure layer protrude into the region of the carrier layer openings. There is consequently also a higher level of resistance with respect to aggressive printing media since the upper regions of the printing openings are formed by the more resistant carrier layer material.

Preferably, the at least one printed image opening according to a first embodiment of the present invention is constructed to be narrower, that is to say, in particular to have a smaller opening width, than the one or more carrier layer openings. This has the advantage that cleaning of the printing stencil can be further facilitated after the printing from the doctor-blade side. In addition, this makes it possible for carrier layer openings to be produced with less precision in a more efficient manner since a high level of precision of the geometry of the carrier layer openings is not required for high quality of the printed image since the printed image and the quality thereof is dependent only on the narrower openings in the structure layer. The production of the carrier layer can consequently be carried out in a more simple and efficient manner since lower quality requirements can be placed on the geometry of the carrier layer openings.

According to a particularly preferred second embodiment of the present invention, which is an alternative to the first embodiment, the one or more carrier layer openings are constructed to be narrower, that is to say, in particular to have a smaller opening width, than the printed image opening. Consequently, there is the advantage that, when pressure is applied by the doctor blade in the entire region of the structure layer from above, the structure layer can be stabilised by the carrier layer, in particular as far as the edge regions of the printed image openings of the structure layer, such that, during printing in the edge region of the printed image openings, an even further improved sealing effect between the substrate surface and the structure layer can be achieved. Furthermore, during printing, the paste can be applied to the substrate through the narrower openings of the carrier layer with a higher doctor-blade pressure such that the paste in the region between the carrier layer and the substrate to be printed can be filled in a complete and uniform manner, in particular also in regions below any webs of the carrier layer which optionally separate a plurality of carrier layer openings for stabilising the stencil and below which no material of the structure layer is provided.

Another great advantage of a printing stencil in which the one or more carrier image openings are constructed to be narrower, that is to say, in particular to have a smaller opening width, than the one or more printed image openings is achieved by the flexibility relating to the possibilities in the production method of the printing stencil. With such a printing stencil, it is both possible to form the carrier layer openings before and after applying the structure layer and to form the printed image openings in the structure layer, for example preferably by means of laser cutting, etching or galvanic methods. In contrast, with printing stencils having a printed image opening which is constructed to be narrower, it is only possible to first provide the carrier layer with the carrier layer openings and afterwards to apply the structure layer and to apply the printed image openings in the structure layer since the structure layer could otherwise be damaged when the carrier layer openings are formed.

Preferably, the printed image opening and/or the one or more carrier layer openings is/are constructed in a substantially rectangular manner. Substantially rectangular is intended in this instance to mean that the corners may be rounded.

Preferably, the printing stencil has a first carrier layer opening and a second carrier layer opening, which are separated by a web of the carrier layer, in particular preferably a web having a width less than or equal to 50 μm, in a particularly preferred manner below 35 μm. In the case of an elongate printed image opening and/or in the case of elongate carrier openings, such a web extends preferably transversely, in a particularly preferred manner perpendicularly, relative to the longitudinal direction of the printed image opening and/or the carrier openings.

A web in the carrier layer affords the advantage that the printing stencil, even in the case of an elongate printed image opening, for example in accordance with an elongate contact finger of the contacting, can be formed by means of one or more webs between adjacent carrier layer openings. Below the webs, there is preferably provided in this instance no material of the structure layer, in particular the web preferably bridges the printed image opening in the structure layer such that the first and second carrier layer openings separated by the web overlap with respect to the same printed image opening of the structure layer.

Preferably, one or more webs are provided, the spacing between two webs or the spacing of a web with respect to an end portion of the carrier opening being in a range between 100 and 500 μm, preferably between 250 and 500 μm. With printed image opening widths in the range between 50 and 100 μm, there is consequently a high level of stability of the printing stencil at the same time as occurrences are prevented of irregularity in the printed image owing to an excessively high web density and, similarly, of irregularity owing to the screen web meshes and mesh knots in the printing region with the printing screens described above.

Preferably, the material of the carrier layer comprises metal, in particular high-grade steel or nickel, and/or plastics material. The carrier layer preferably consists of metal, in particular high-grade steel or nickel, and/or plastics material. Preferably, the carrier layer comprises one or more metal layers and/or one or more plastics material layers. Preferably, the carrier layer comprises or the carrier layer consists of a metal sheet.

The carrier layer preferably has a layer height of greater than or equal to 10 μm.

Preferably, the structure layer is produced from a fluid or solid, preferably light-sensitive material, particularly preferably from a light-sensitive photographic emulsion. Consequently, the structure layer can be applied in a simple manner to the carrier layer or another intermediate layer, the printed image openings being able to be subsequently formed in a particularly precise and efficient manner by means of substrate-side illumination of the printing stencil and subsequent development of the structure layer produced from the light-sensitive material, in particular the photographic emulsion layer. Preferably, the light-sensitive material can be illuminated in a negative manner or illuminated in a positive manner.

Preferably, the structure layer has a layer height greater than or equal to 5 μm.

Preferably, the structure layer is applied to the carrier layer or an intermediate layer located between the structure layer and the carrier layer.

Preferably, the carrier layer has a surface structure on the side to which the structure layer is applied. This facilitates the application of the structure layer to the carrier layer by providing a greater bonding effect on the substrate-side surface of the carrier layer, in particular when photographic emulsions are used.

Preferably, the carrier layer and/or the entire stencil is surface-treated in order to improve the printing behaviour, in particular by means of at least one from among varnishing, coating and roughening operations.

Preferably, the width of the printed image opening is greater than or equal to 35 μm and/or less than or equal to 150 μm.

According to the present invention, there is further provided a method for producing a printing stencil according to at least one of the above aspects. The method according to the invention comprises the steps of providing a carrier layer, providing a structure layer which is located below the carrier layer (that is to say, in particular on the substrate side), forming at least one printed image opening which corresponds to at least a portion of the printed image of the printing pattern, in particular the contacting, in the structure layer and forming one or more carrier layer openings in the carrier layer.

According to the invention, the printed image opening and the one or more carrier layer openings are formed in such a manner that the one or more carrier layer openings, when the printing stencil is viewed from above, overlap with respect to the printed image opening in such a manner that the printing stencil has an opening which is formed from the at least one printed image opening and the one or more carrier layer openings and is suitable for applying a print medium to the substrate through the opening.

Preferably, the step of providing a structure layer which is located above the carrier layer comprises a step of coating the structure layer with the material of the structure layer or coating an intermediate layer with the material of the structure layer.

According to a first preferred embodiment, the printed image opening and the one or more carrier layer openings is/are preferably formed in such a manner that the printed image opening is constructed to be narrower than the one or more carrier layer openings.

According to a second preferred embodiment, which is an alternative to the first embodiment, the printed image opening and the one or more carrier layer openings are preferably formed in such a manner that the one or more carrier layer openings is/are constructed to be narrower than the printed image opening.

Preferably, the steps of the method are carried out in the following order: first, providing the carrier layer, for example by means of clamping in a frame, then forming the one or more carrier layer openings in the carrier layer, for example by means of laser processing, etching and/or galvanic methods, afterwards providing the structure layer which is located below the carrier layer which already has the carrier openings, and subsequently forming the at least one printed image opening in the structure layer, for example by means of illumination and development, when a photographic emulsion layer or light-sensitive structure layer is used.

Alternatively, the steps of the method according to another embodiment are carried out in the following order: first, providing the carrier layer, for example by means of clamping in a frame, then providing the structure layer located below the carrier layer, then forming at least one printed image opening in the structure layer, for example by means of illumination and development, when a photographic emulsion layer or light-sensitive structure layer is used, and subsequently forming the one or more carrier layer openings in the carrier layer. However, this is only advantageous when the printed image opening is constructed to be wider or to have the same width as the at least one carrier layer opening to be formed, since otherwise the structure layer could become damaged when the carrier layer opening is formed.

Preferably, the step of forming the one or more carrier layer openings in the carrier layer is carried out by means of laser cutting, etching and/or a galvanic method.

Preferably, the structure layer is produced from a fluid or solid, light-sensitive material, in particular from a light-sensitive photographic emulsion, the step of forming at least one printed image opening in the structure layer preferably comprising the following steps: illuminating the structure layer by means of electromagnetic radiation of a predetermined wavelength or of a predetermined wavelength range, in particular by means of infrared, visible and/or ultraviolet light, with a printed image and developing the illuminated light-sensitive material of the structure layer.

Preferably, the step of providing the structure layer located below the carrier layer comprises the steps of providing an intermediate layer below the carrier layer and applying the structure layer to the intermediate layer. Alternatively, the step of providing the structure layer located below the carrier layer preferably comprises the step of applying the structure layer to the carrier layer.

Preferably, the method comprises the additional step of forming a surface structure on the side of the carrier layer facing the structure layer in order to be able to improve a bonding action when the structure layer is applied and to facilitate the application of the structure layer.

The method preferably comprises the additional step of surface treating the carrier layer and/or the entire stencil in order to improve the printing behaviour, in particular by means of at least one from among varnishing, coating and roughening operations.

### BRIEF DESCRIPTION OF THE FIGURES

FIG. 1 is a plan view of a solar cell known from the prior art.

FIG. 2A is a plan view of a cutout of a printing screen known from the prior art and FIG. 2B is a cross-section of the cutout of the printing screen of FIG. 2B known from the prior art.

FIG. 3A is a cross-section through a cutout of a printing stencil according to a first embodiment of the present invention. FIG. 3B is a doctor-blade-side plan view of the cutout of the printing stencil from FIG. 3A, and FIG. 3C is a substrate-side plan view of the cutout of the printing stencil from FIG. 3A.

FIG. 4A is a cross-section through a cutout of a printing stencil according to a second embodiment of the present invention. FIG. 4B is a doctor-blade-side plan view of the cutout of the printing stencil of FIG. 4A, and FIG. 4C is a substrate-side plan view of the cutout of the printing stencil from FIG. 4A.

### DETAILED DESCRIPTION OF THE FIGURES AND PREFERRED EMBODIMENTS OF THE INVENTION

Various embodiments of the present invention are described in a detailed manner below with reference to the Figures. Elements which are the same or similar in the Figures are given the same reference numerals in this instance. However, the present invention is not limited to the construction features described but instead further encompasses modifications to features of the embodiments described and combinations of features from various embodiments in the context of the protective scope of the independent claims.

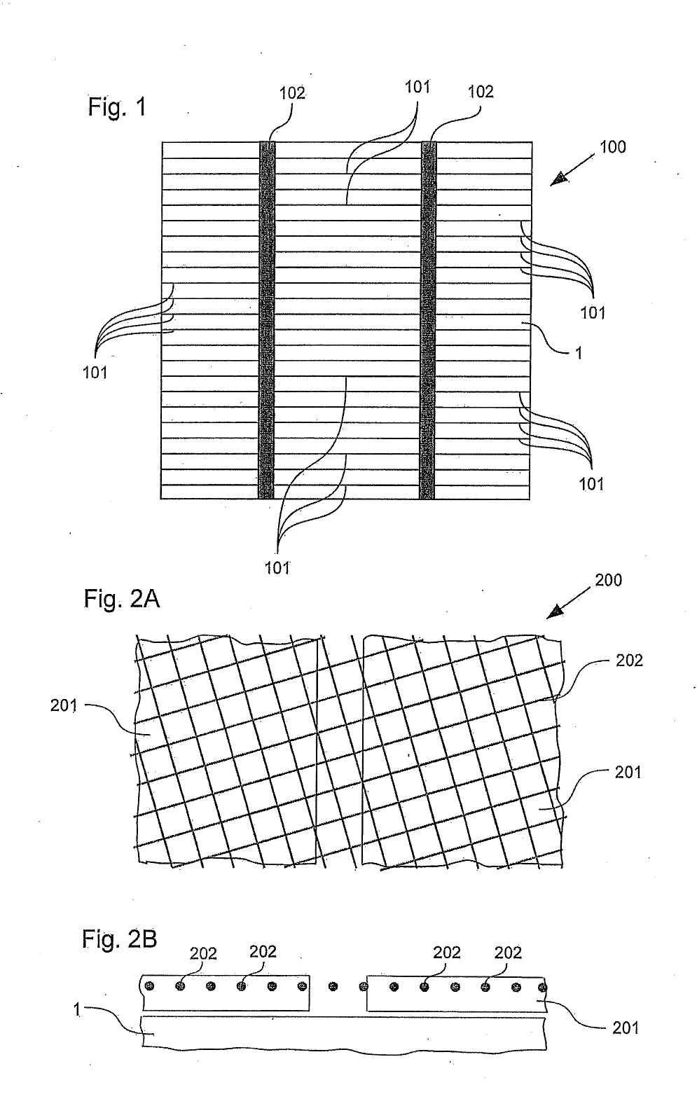

FIG. 1 is by way of example a plan view of a solar cell 100 known from the prior art. The solar cell 100 comprises a substantially rectangular light-active semi-conductor photovoltaic substrate layer, referred to below in abbreviated form as substrate 1, on which on the front side a front contacting with two (optionally also a plurality of) electrically conductive, mutually parallel bus bars 102 for discharging the electrical energy and for connecting the solar cell 100 to other solar cells to form a solar cell module. In a state perpendicular relative to the busbars 102 there are provided a large number of contact fingers 101 which also extend parallel to each other but extend transversely relative to the busbars 102 as a component of the front contacting. These direct the electrical energy produced when light strikes the substrate 1 to the busbars 102. In order to allow a high level of energy efficiency of solar cells by means of low electrical resistances of the conductor paths and, at the same time, the lowest possible level of shading, the contact fingers 101 should be applied with the largest possible aspect ratio which is uniform over the entire length of the contact fingers 101, that is to say, great height and minimum width.

FIG. 2A is by way of example a plan view of a cutout of a printing screen 200 known from the prior art, and FIG. 2B is by way of example a cross-section of the cutout of the printing screen 200 of FIG. 2B known from the prior art. The printing screen 200 comprises a photographic emulsion layer 201, which has a printed image opening for printing the front-side contacting. The photographic emulsion layer is stabilised by means of a screen fabric 202 which is introduced in the photographic emulsion layer 210. In this instance, there is in particular the disadvantage that the screen fabric 202 also fills the free printing region of the printed image opening and consequently may lead to a non-uniform application of paste when printing the front-side contacting, in particular in the region of the mesh knots of the screen fabric 202.

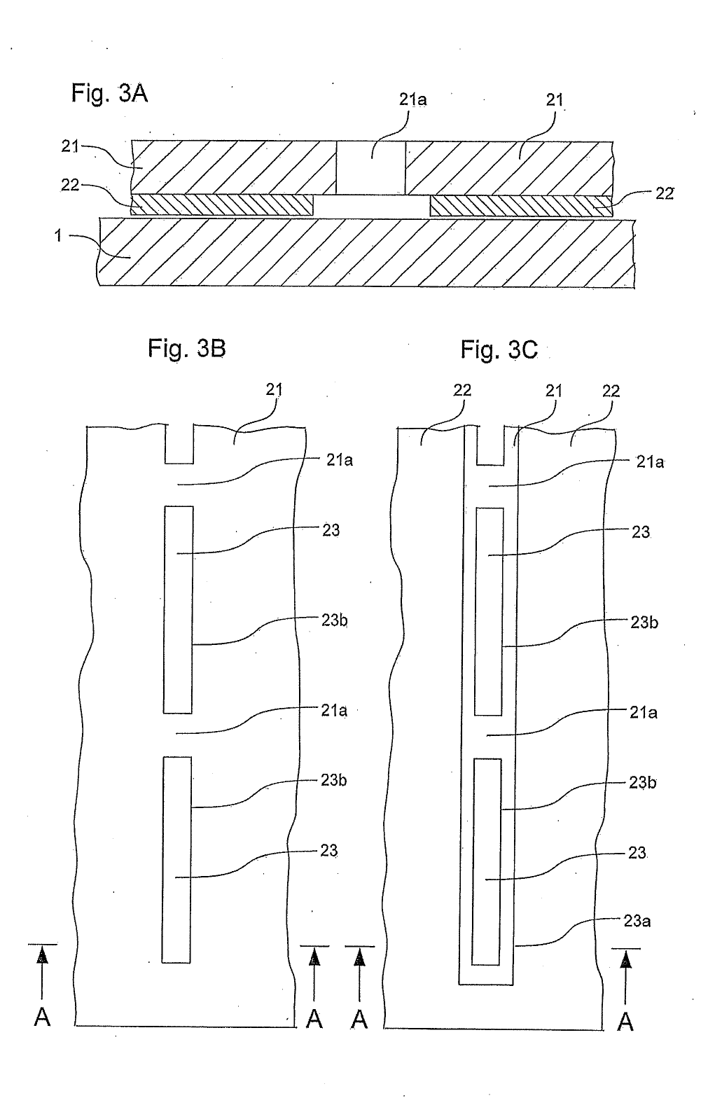

FIG. 3A is by way of example a cross-section through a cutout of a printing stencil 2 according to a first embodiment of the present invention. FIG. 3B is by way of example a doctor-blade-side plan view of the cutout of the printing stencil 2 from FIG. 3A, and FIG. 3C is by way of example a substrate-side plan view 2 of the cutout of the printing stencil from FIG. 3A. The cross-section in FIG. 3A extends along the line of section A-A in FIGS. 3B and 3C.

The printing stencil 2 comprises a doctor-blade-side carrier layer 21, for example made of a metal such as high-grade steel or nickel, or plastics material, and a substrate-side structure layer 22, for example made of a photographic emulsion.

The carrier layer 21 comprises elongate, rectangular carrier layer openings 23b which are each separated from the other by means of a web 21a. The structure layer comprises an elongate, rectangular printed image opening 23a, which corresponds to at least a portion of a printed image of a front-side contacting of a solar cell 100 to be printed, in particular at least a portion of a printed image corresponding to a contact finger 101 of the front-side contacting to be printed.

In the printing stencil 2, the printed image opening 23a and the carrier layer openings 23b which are located thereabove consequently provide an opening 23 through which the printing paste can be applied by means of a doctor blade to the substrate 1 in order to print at least a portion of the front contacting. The carrier layer openings 23b overlap in particular when the printing stencil 2 is viewed from above (that is to say, in the viewing direction according to FIG. 3B or 3C) with respect to the printed image opening 23a in such a manner that the printing stencil 2 has the openings 23 which are formed from the printed image opening 23a and the carrier layer openings 23b and is suitable for applying the printing paste to the substrate 1 through the openings 23. In this instance, the carrier layer openings 23b have peripherally exposed opening walls. The webs 21a span the printed image opening 23a of the structure layer 22, and below the webs 21a there is no material of the structure layer 22.

As can be seen in particular in FIGS. 3A and 3C, the carrier layer openings 23b in this embodiment of the present invention are constructed to be narrower than the printed image opening 23a. In particular, the carrier layer openings 23b have in this embodiment of the present invention a smaller opening width than the printed image opening 23a. This allows particularly good flexibility in the production of the printing stencil 2 since the carrier layer openings 23b can be formed both before and after application of the structure layer 22 to the carrier layer 21 and formation of the printed image opening 23a, without damaging the structure layer 21 or the optionally already formed printed image opening 23a. In addition, the structure layer, which is generally softer, can advantageously be stabilised by means of the carrier layer as far as the edges thereof at the openings 23a of the printed image.

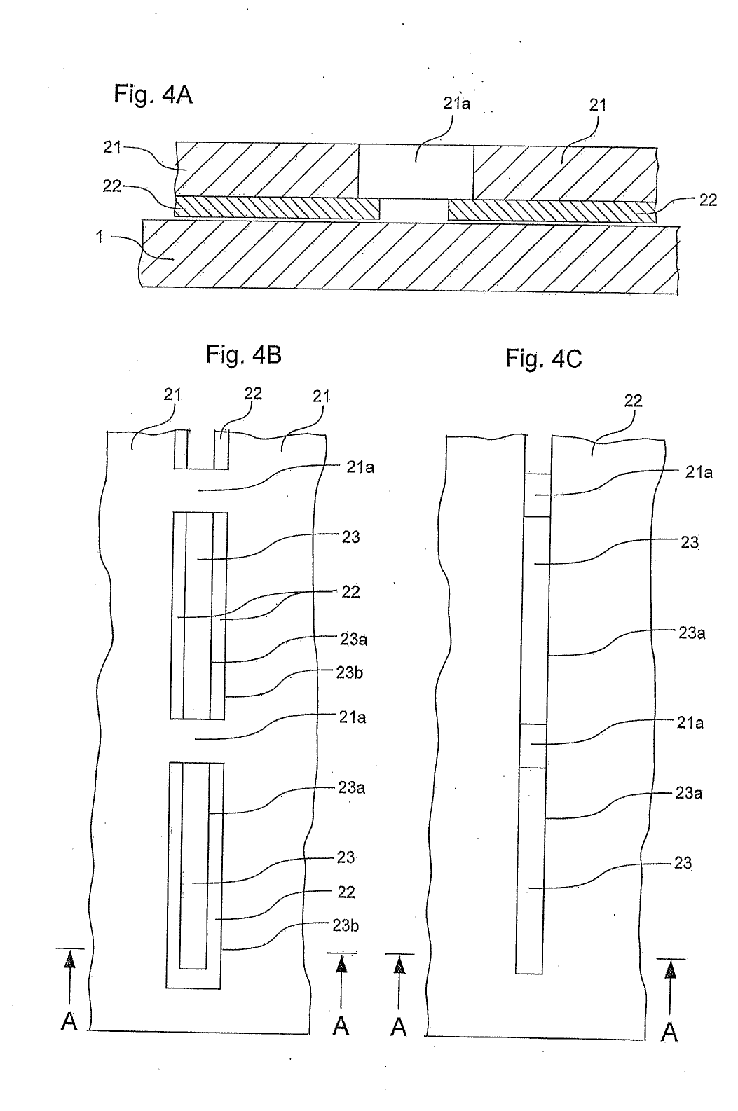

FIG. 4a is by way of example a cross-section through a cutout of a printing stencil 2 according to a second embodiment of the present invention. FIG. 4b is by way of example a doctor-blade-side plan view of the cutout of the printing stencil from FIG. 4A, and FIG. 4c is by way of example a substrate-side plan view of the cutout of the printing stencil from FIG. 4A. The cross-section in FIG. 4A extends along the line of section A-A in FIGS. 4B and 4C.

The printing stencil 2 again comprises a doctor-blade-side carrier layer 21, for example made of a metal such as high-grade steel or nickel, or a plastics material, and a substrate-side structure layer 22, for example made of a photographic emulsion.

The carrier layer 21 comprises elongate carrier layer openings 23b, which are each separated from the other by means of a web 21a. The structure layer comprises an elongate printed image opening 23a.

In the printing stencil 2 the printed image opening 23a and the carrier layer openings 23b which are located thereabove consequently provide an opening 23 through which the printing paste can be applied by means of a doctor blade to the substrate 1 in order to print the front contacting. The carrier layer openings 23b overlap in particular, when the printing stencil 2 is viewed from above (that is to say, in the viewing direction according to FIG. 4B or 4C), with respect to the printed image opening 23a in such a manner that the printing stencil 2 has the openings 23 which are formed from the printed image opening 23a and the carrier layer openings 23b and is suitable for applying the printing paste to the substrate 1 through the openings 23. In this instance, the carrier layer openings 23b have peripherally exposed opening walls. The webs 21a span the printed image opening 23a of the structure layer 22, and below the webs 21a there is no material of the structure layer 22 in the region of the printed image opening 23a.

As can be seen in particular in FIGS. 4A and 4C, the carrier layer openings 23b in this embodiment of the present invention are constructed to be wider than the printed image opening 23a. In particular, the carrier layer openings 23b in this embodiment of the present invention have a larger opening width than the printed image opening 23a. This advantageously allows simpler and more efficient production of the carrier layer since the requirements in terms of the precision when forming the carrier layer openings can be reduced since the precision of the printed image is determined by the precision of the geometry of the formed printed image openings in the structure layer which can be ensured in a simple manner during an illumination method.

In summary, the present invention provides, in particular in comparison with the use of printing screens, an improved solution for the application of a contacting to a substrate, in particular to a substrate of a solar cell, with which the contacting and in particular the contact fingers can be applied with a more uniform printed image. The present invention provides in particular an improved solution for the application of a contacting to a substrate, in particular to a substrate of a solar cell, with which the contact fingers can be applied with the highest possible aspect ratio which is uniform over the entire length of the contact fingers.

Finally, there is particularly provided an improved solution for the application of a contacting to a substrate, in particular to a substrate of a solar cell, with which occurrences of unevenness in the overall printed image when different printing media are used with different printed images can be prevented and furthermore longer service-lives can also be achieved. When a printing stencil is used, stencil changes are required less often than screen changes are when printing screens are used, with the result that time can be saved owing to fewer changes (that is to say, shorter machine down-times).

1. A printing stencil for applying a printing pattern to a substrate, comprising:
a carrier layer and
a structure layer which is located below the carrier layer, wherein
the structure layer has at least one printed image opening which corresponds to at least a portion of the printed image of the printing pattern,
the carrier layer has one or more carrier layer openings and
the one or more carrier layer openings overlap, when the printing stencil is viewed from above, with respect to the printed image opening in such a manner that the printing stencil has an opening which is formed from the at least one printed image opening and the one or more carrier layer openings and is suitable for applying a print medium through the opening to the substrate.

2. The printing stencil according to claim 1, wherein the one or more carrier layer openings have opening walls which are peripherally exposed.

3. The printing stencil according to claim 1, wherein the printed image opening is constructed to be narrower than the one or more carrier layer openings.

4. The printing stencil according to claim 1, wherein the one or more carrier layer openings is constructed to be narrower than the printed image opening.

5. The printing stencil according to claim 1, wherein the printed image opening and/or the one or more carrier layer openings is constructed in a substantially rectangular manner or with round opening edges.

6. The printing stencil according to claim 1, wherein the printing stencil has a first carrier layer opening and a second carrier layer opening which are separated by a web of the carrier layer, the web of the carrier layer having a width less than or equal to 50 μm.

7. The printing stencil according to claim 1, wherein the material of the carrier layer comprises a metal.

8. The printing stencil according to claim 1, wherein the structure layer is produced from a fluid or a solid material.

9. The printing stencil according to claim 1, wherein the structure layer is applied to the carrier layer or an intermediate layer which is located between the structure layer and the carrier layer.

10. The printing stencil according to claim 1, wherein the carrier layer has a surface structure on the side to which the structure layer is applied.

11. The printing stencil according to claim 1, wherein the surface of the carrier layer and/or the surface of the entire stencil is surface-treated, wherein the surface treatment is at least one treatment selected from the group consisting of varnishing, coating, and roughening operations.

12. A method for producing a printing stencil according to claim 1, comprising:
providing a carrier layer,
providing a structure layer located below the carrier layer,
forming at least one printed image opening, which corresponds to at least a portion of the printed image, in the structure layer and
forming one or more carrier layer openings in the carrier layer,
wherein the printed image opening and the one or more carrier layer openings are formed in such a manner that the one or more carrier layer openings overlap, when the printing stencil is viewed from above, with respect to the printed image opening in such a manner that the printing stencil has an opening which is formed from the at least one printed image opening and the one or more carrier layer openings and is suitable for applying a print medium through the opening to the substrate.

13. The method according to claim 12, wherein the step of providing a structure layer which is located above the carrier layer comprises a step of coating the structure layer with the material of the structure layer or coating an intermediate layer with the material of the structure layer.

14. The method according to claim 12, wherein the printed image opening and the one or more carrier layer openings is formed in such a manner that the printed image opening is constructed to be narrower than the one or more carrier layer openings.

15. The method according to claim 12, wherein the printed image opening and the one or more carrier layer openings are formed in such a manner that the one or more carrier layer openings is constructed to be narrower than the printed image opening.

16. The method according to claim 14, wherein the steps of the method are carried out in the following order:
providing the carrier layer,
forming the one or more carrier layer openings in the carrier layer,
providing the structure layer located below the carrier layer, and
forming the at least one printed image opening in the structure layer.

17. The method according to claim 15, wherein the steps of the method are carried out in the following order:
providing the carrier layer,
providing the structure layer located below the carrier layer,
forming at least one printed image opening in the structure layer and
forming the one or more carrier layer openings in the carrier layer.

18. The method according to claim 12, wherein the step of forming the one or more carrier layer openings in the carrier layer is carried out by means of laser cutting, etching and/or a galvanic method.

19. The method according to claim 12, wherein the structure layer is produced from a fluid or a solid material.

20. The method according to claim 12, wherein the structure layer comprises a light-sensitive material, in particular a light-sensitive photographic emulsion, wherein the step of forming at least one printed image opening in the structure layer comprises:
illuminating the structure layer by means of electromagnetic radiation of a predetermined wavelength or of a predetermined wavelength range, in particular by means of infrared, visible and/or ultraviolet light, with a printed image of the printing pattern of the solar cell, and
developing the light-sensitive material of the structure layer.

21. The method according to claim 12, wherein the step of providing the structure layer which is located below the carrier layer comprises the steps of providing an intermediate layer below the carrier layer and applying the structure layer to the intermediate layer, or in that the step of providing the structure layer located below the carrier layer comprises the step of applying the structure layer to the carrier layer.

22. The method according to claim 12, further comprising forming a surface structure on the side of the carrier layer facing the structure layer.

23. The method according to claim 12, wherein the additional step of surface-treating the carrier layer and/or the entire printing stencil in order to improve the printing behavior, wherein the surface-treating is at least one selected from the group consisting of varnishing, coating and roughening operations.
